(19) United States
(12) Patent Application Publication
(10) Pub. No.: US 2007/0242613 A1
(43) Pub. Date: Oct. 18, 2007

(54) Communication device and communication status notification method

(75) Inventor: Motoo Shigetoshi, Asaka-shi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM CORPORATION, Tokyo (JP)

(21) Appl. No.: 11/785,353

(22) Filed: Apr. 17, 2007

(30) Foreign Application Priority Data
Apr. 18, 2006 (JP) 2006-114716

(51) Int. Cl. H04J 1/16

(52) U.S. Cl. 370/244

(57) ABSTRACT

The communication device according to an aspect of the present invention comprises a contact part which contacts a human body, a communication section which performs data communication through the human:body in contact with the contact part, an energy generating section which generates energy including at least one of mechanical energy, heat energy, and light energy to apply the energy to the contact part, a status detection section which detects a status of the data communication of the communication section, and a communication status notification section which controls start, continuation, or stop of the energy generation of the energy generating section depending on the status of the data communication detected by the status detection section.

### BACKGROUND OF THE INVENTION

1. Field of the Invention

The present invention relates to human body communications, and particularly to a technology for providing easily understandable notification of a status of a human body communication.

2. Description of the Related Art

In recent years, a human body communication system which communicates through a user's human body has been developed. For example, according to Japanese. Patent Application Laid-Open No. 2004-120097, an operating error such as an inadvertent operation is prevented by providing an electrode of a human body communication integrated with a switch and performing ID matching only when the switch is pressed. Additionally, according to Japanese Patent Application Laid-Open No. 2002-9710, a body-worn human body communication device supplies power to a circuit after receiving of a start signal from its partner's human body communication device so that energy consumption is reduced when communication is not being performed.

### SUMMARY OF THE INVENTION

In the technologies according to the above documents, although communication is enabled when a user touches an electrode, the user cannot know a status of the human body communication after touching the electrode. A separate display device may be provided to give notification of a communication status. However, in this case, a user cannot know communication status without changing the user's view direction to watch the display device. The present invention is made in view of these problems, and is intended to allow a user's body to sense a status of human body communication from the neighborhood of a part which the body touches.

A communication device according to the present invention includes a contact part which contacts a human body, a communication section which performs data communication through the human body in contact with the contact part, an energy generating section which generates energy including at least one of mechanical energy, heat energy, and light energy to apply the energy to the contact part, a status detection section which detects a status of the data communication of the communication section, and a communication status notification section which controls start, continuation, or stop of the energy generation of the energy generating section depending on the status of the data communication detected by the status detection section.

This allows a user to sense a communication status from energy such as mechanical power, heat, or light applied to a contact part which contacts the user's body.

Preferably, the energy generating section includes a vibration generating section which generates vibration force.

Preferably, the energy generating section includes a heat radiating section which radiates heat to a human body contacting side of the contact part.

Preferably, the energy generating section includes a heat absorbing section which absorbs heat from a human body contacting side of the contact part.

Preferably, the energy generating section includes an absorption section which sticks the human body in contact with the contact part to the contact part.

Preferably, the communication device further includes a projecting part configured to be projectable to a human body contacting side of the contact part and be retractable to a human body non-contacting side of the contact part, wherein the energy generating section includes a drive section which drives operation of projection or retraction of the projecting part.

Preferably, the energy generating section includes a light emitting section which emits light to a human body contacting side of the contact part.

Preferably, the communication status notification section controls start or stop of the energy generation of the energy generating section depending on detection of start or end of the data communication by the status detection section.

Preferably, the communication status notification section controls the energy generation to be continued since the status detection section detects the start of the data communication until the status detection section detects the end of the data communication.

Preferably, the communication status notification section changes a pattern of the energy generation of the energy generating section depending on the status of the data communication detected by the status detection section.

This allows a user to sense a communication status from a pattern of energy generation from the contact part.

A communication device according to the present invention includes a contact part which contacts a human body, a communication section which performs data communication through the human body in contact with the contact part, a light emitting section which irradiates light to a neighborhood of a human body contacting side of the contact part, a status detection section which detects a status of the data communication of the communication section, and a communication status notification section which controls start, continuation, or stop of light emission of the light emitting section depending on the status of the data communication detected by the status detection section.

This allows a user to sense a communication status from light of the neighborhood of the contact part.

A communication status notification method according to the present invention is a communication status notification method used in a communication device including a contact part which contacts a human body and a communication section which performs data communication through the human body in contact with the contact part, the method including the steps of detecting a status of the data communication of the communication section, and generating energy including at least one of mechanical energy, heat energy, and light energy to apply the energy to the contact part depending on the detected status of the data communication.

A communication status notification method according to the present invention is a communication status notification method used in a communication device including a contact part which contacts a human body and a communication section which performs data communication through the human body in contact with the contact part, the method including the steps of detecting a status of the data communication of the communication section, and irradiating light to a neighborhood of a human body contacting side of the contact part depending on the detected status of the data communication.

### ADVANTAGE OF THE INVENTION

According to the present invention, a user can easily sense a communication status from energy such as mechanical power, heat, or light applied to a contact part which contacts the user's body or from light irradiated to a neighborhood of the contact part.

### BRIEF DESCRIPTION OF THE DRAWINGS

FIG. 1 is a block diagram of a communication system;

FIG. 2 is a human body communication section according to a first embodiment;

FIG. 3 is a flowchart which shows a flow of communication processing according to the first embodiment;

FIG. 4 is a flowchart which shows a flow of communication processing according to a second embodiment;

FIG. 5 is a block diagram of a human body communication section according to a third embodiment;

FIG. 6 is a flowchart which shows a flow of communication processing according to the third embodiment;

FIG. 7 is a block diagram of a human body communication section according to a forth embodiment;

FIG. 8 is a block diagram of a human body communication section (in which a protrusion is not formed) according to a fifth embodiment;

FIG. 9 is a block diagram of the human body communication section (in which a protrusion is formed) according to the fifth embodiment; and

FIG. 10 is a block diagram of a human body communication section according to a sixth embodiment.

### DETAILED DESCRIPTION OF THE PREFERRED EMBODIMENTS

### First Embodiment

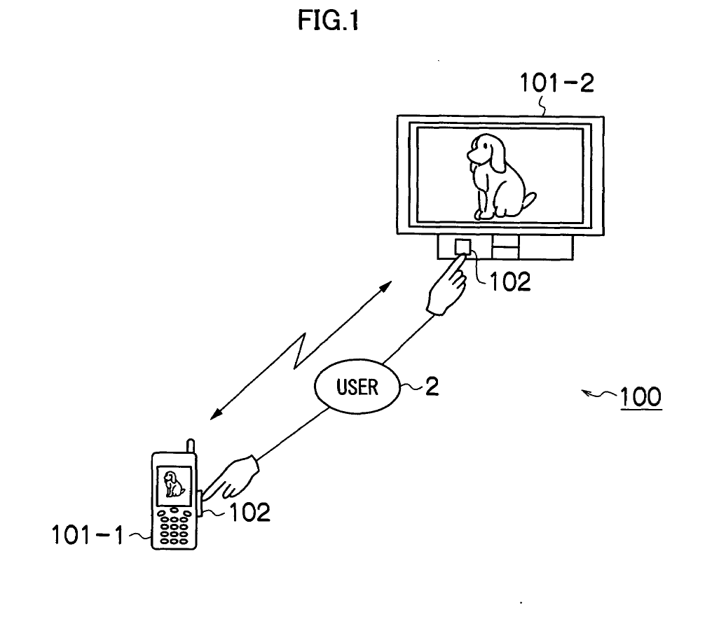

FIG. 1 shows one example of a configuration of a communication system 100 according to a preferred embodiment of the present invention. The communication system 100 includes a first communication device 101-1 and a second communication device 101-2. The first communication device 101-1 or the second communication device 101-2 may be, for example, a mobile telephone, a PDA, a wristwatch, an automobile or an intelligent key thereof, a notebook computer, a television, an electronic photo stand, or the like, and may be configured in any specific manner and used in any form. For example, it may be configured to be attachable to a human body.

The first communication device 101-1 and the second communication device 101-2 have respective human communication sections 102 which send/receive data each other through a user's human body 2.

For example, while the user touches the human communication section 102 of the first communication device 101-1 with one of the user's hands, the user touches the human communication section 102 of the second communication device 101-2 with the other of the user's hands. Then, the first communication device 101-1 and the second communication device 101-2 are electrically connected through the user's human body 2 and communicate necessary data each other.

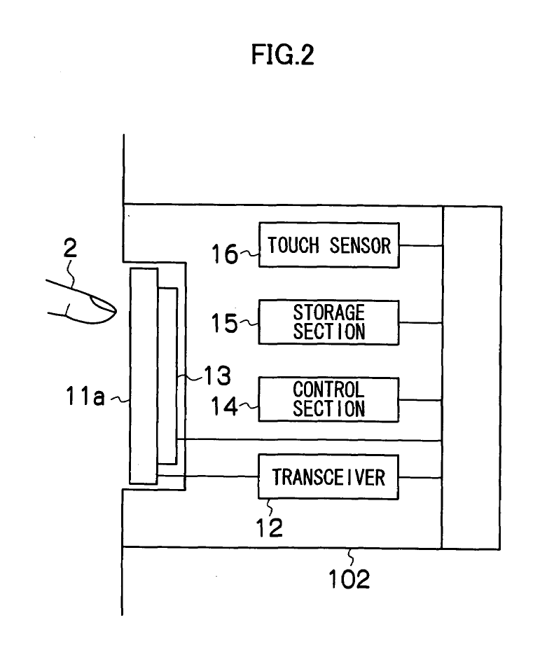

FIG. 2 is a block diagram of the human body communication section 102 according to the first embodiment. The human body communication section 102 has a human body contact part 11a which contacts the human body 2, a transceiver 12, a vibration generator 13, a control section 14, a storage section 15, and a touch sensor 16.

The human body contact part 11a is an electrode composed of, for example, an electrically conductive member. The human body contact part 11a may also be hereinafter referred to as an electrode 11a. The transceiver 12 modulates a digital signal which indicates various information to several tens to several hundreds kHz as a weak current of several hundred microamperes and transmits the modulated signal to the human body communication section 102 of the other party through the human body 2 in contact with the electrode 11a. Alternatively, the transceiver 12 receives a weak current from the human body communication section 102 of the other party and demodulates it into a digital signal. This allows data communication at several ten kbps between the human body communication sections 102, and therefore, for example, 128-bit information can be transmitted in several ten milliseconds. Preferably, information is transmitted several times or several ten times redundantly because a communication status of the transceiver 12 depends on a contact condition between the human body 2 and the electrode 11a.

The vibration generator 13 is a small device composed of a piezoelectric element, a-motor, or the like which generates vibration force. The vibration generator 13 is configured to transmit vibration force generated by the vibration generator 13 only to the electrode 11a by, for example, contacting a vibrating plate stuck to an electrode of a piezoelectric element with the electrode 11a.

The control section 14 is composed of a CPU and the like, and centrally controls operation of each part. Such operations include start and end of sending/receiving of information by the transceiver 12, start and end of vibration of the electrode 11a by the vibration generator 13, and the like. The storage section 15 is composed of a flash memory, a RAM, or the like, and temporarily or continuously stores various data and programs required for processing by the control section 14.

The touch sensor 16 is, for example, a capacitance type sensor formed on the electrode 11a. When the touch sensor 16 detects, from change of capacitance or the like, that the human body 2 contacts the electrode 11a or that contact of the human body 2 is released, the touch sensor 16 outputs a contact sense signal or a contact release sense signal to the control section 14.

The transceiver 12 notifies the control section 14 of start/end of data sending from the transceiver 12 itself, start/end of data receiving from the other party, occurrence of an error during data sending and receiving, or other communication statuses. The control section 14 detects a communication status of the transceiver 12 by the communication status notification from the transceiver 12.

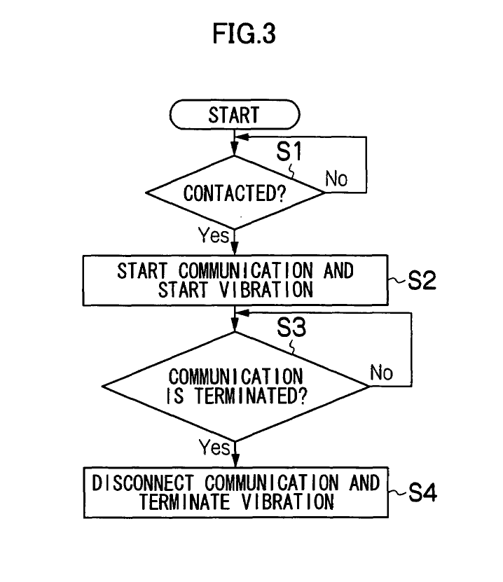

FIG. 3 is a flowchart which shows a flow of communication processing performed by the human body communication section 102.

In S1, the control section 14 continuously determines whether or not a contact sense signal is outputted from the touch sensor 16. When the control section 14 determines that the sense signal is outputted, the processing proceeds to S2.

In S2, the control section 14 controls the transceiver 12 to start sending/receiving of desired data. In addition, the control section 14 controls the vibration generator 13 to start generation of vibration force by controlling a driver or the like (not shown) connected to the vibration generator 13. Control of the start of data sending/receiving of the transceiver 12 may be started immediately when it is determined that a contact sense signal is outputted from the touch sensor 16, or may be synchronized with control of the start of generation of vibration force. The vibration generator 13 continues the generation of vibration force until the vibration generator 13 is controlled to stop the generation of vibration force by the control section 14.

In S3, the control section 14 determines whether communication of the desired data by the transceiver 12 is terminated or not. This can be determined by, for example, whether or not the self transceiver 12 sends the desired data and receives a signal from the human body communication section 102 of the other party which indicates it received the desired data. When the control section 14 determines that the communication of the data is terminated, the processing proceeds to S4.

Alternatively, it may be determined that the communication of the data is terminated when it is determined that a contact release sense signal is outputted from the touch sensor 16 or when it is determined that a communication error of the transceiver 12 occurs.

In S4, the control section 14 controls the transceiver 12 to disconnect its communication and controls the vibration generator 13 to stop the generation of vibration force.

According to the above described processing, since a user can sense that communication is being performed from vibration force transmitted from the electrode 11a when the user contacts the user's human body 2 with the electrode 11a, the user can intuitively know start, continuation and end of the communication between the first communication device 101-1 and the second communication device 101-2 through the human body 2.

### Second Embodiment

Although, in the first embodiment, generation of vibration force is continued as long as communication is continued, vibration force may be generated only when communication is started and/or terminated.

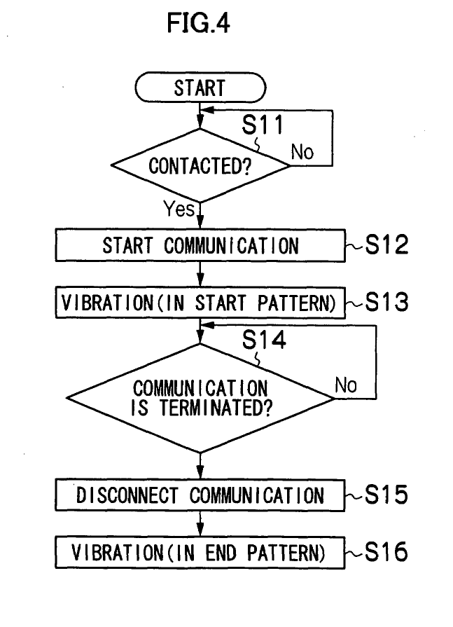

FIG. 4 is a flowchart which shows a flow of communication processing performed by the human body communication section 102.

In S11, the control section 14 continuously determines whether or not a contact sense signal is outputted from the touch sensor 16. When the control section 14 determines that the sense signal is outputted, the processing proceeds to S12.

In S12, the control section 14 controls the transceiver 12 to start sending/receiving of desired data.

In S13, the control section 14 selects vibration pattern data corresponding to “communication start” that is a latest communication status detected by the transceiver 12 from among vibration pattern data stored in the storage section 15. Then, the control section 14 controls vibration generator 13 to vibrate with a pattern based on the selected vibration pattern data only within a predetermined time. Thus, the control section 14 clocks a duration time of generation of vibration force. When the control section 14 determines that the duration time arrives at the predetermined time (for example, 2 seconds), the control section 14 controls the vibration generator 13 to stop the generation of vibration force.

In addition, if the vibration pattern data corresponding to the “communication start” defines a vibration that continues for only a few tenths of a second, an effect similar to a click feeling can be provided to the human body 2.

In S 14, the control section 14 determines whether communication of the desired data by the transceiver 12 is terminated or not. When the control section 14 determines that the communication of the data is terminated, the processing proceeds to S15.

In S15, the control section 14 controls the transceiver 12 to disconnect its communication.

In S16, the control section 14 selects vibration pattern data corresponding to “communication end” that is a latest communication status detected by the transceiver 12 from among vibration pattern data stored in the storage section 15. Then, the control section 14 controls vibration generator 13 to vibrate with a pattern based on the selected vibration pattern data only within a predetermined time. The control section 14 clocks a duration time of generation of vibration force. When the control section 14 determines that the duration time arrives at the predetermined time (for example, 2 seconds), the control section 14 controls the vibration generator 13 to stop the generation of vibration force. Preferably, a vibration pattern corresponding to the “communication start” is different from a vibration pattern corresponding to the “communication end”. For example, both vibration patterns may have a difference in strength, rhythm, rate, duration, or the like of a vibration.

In addition, when it is determined that a communication error of the transceiver 12 occurs, vibration pattern data corresponding to “error end” that is a current status of the transceiver 12 is selected, and vibration generator 13 is controlled to vibrate with a pattern based on the selected vibration pattern data within a predetermined time. If the ;vibration pattern data corresponding to the “error end” has a stronger vibration force pattern than a vibration patterns corresponding to the “communication start” and the “communication end”, the human body 2 can sense that communication is terminated due to an error.

According to the above described processing, when the user contacts the user's human body 2 with the electrode 11a, the user can intuitively know communication statuses such as start, continuation and end by a vibration pattern transmitted from the electrode 11a.

### Third Embodiment

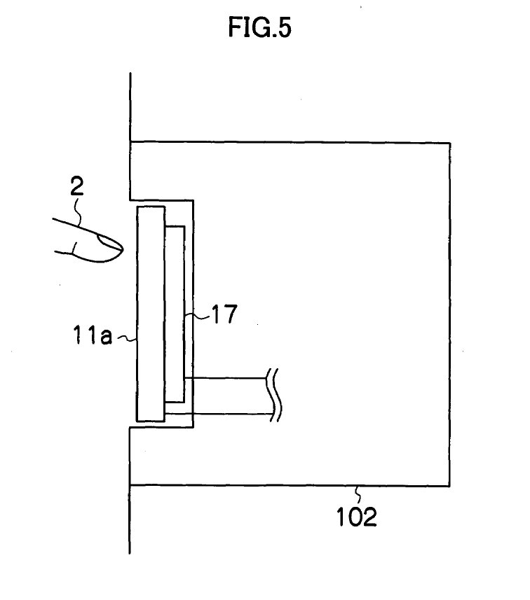

FIG. 5 is a block diagram of the main part of a human communication section 102 according to the third embodiment. The human communication section 102 includes a heating device 17 composed of a peltier element, a heating wire, or the like instead of the vibration generator 13. Other components are similar to those of FIG. 2, and illustrations and descriptions thereof are omitted.

The electrode 11a is composed of an electrically conductive and heat conductive member. Heat generated by the heating device 17 is conducted to the human body 2 in contact with the electrode 11a. Although the heating device 17 and the electrode 11a are separately provided in FIG. 5, if the heating device 17 is composed of an electrically conductive member such as a heating wire, the heating device 17 and the electrode 11a can be integrated in a common structure.

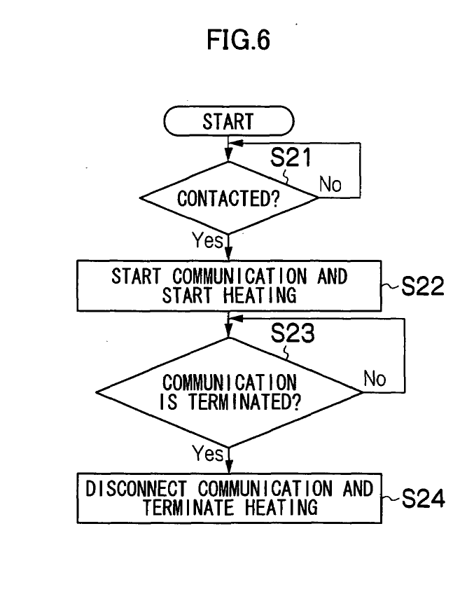

FIG. 6 is a flowchart which shows a flow of communication processing performed by the human body communication section 102.

In S21, the control section 14 continuously determines whether or not a contact sense signal is outputted from the touch sensor 16. When the control section 14 determines that the sense signal is outputted, the processing proceeds to S22.

In S22, the control section 14 controls the transceiver 12 to start sending/receiving of desired data. In addition, the control section 14 controls the heating device 17 to start generation of heat by controlling a driver or the like (not shown) connected to the heating device 17. Control of the start of data sending/receiving of the transceiver 12 may be started immediately when it is determined that a contact sense signal is outputted from the touch sensor 16, or may be synchronized with control of the start of heat generation. The heating device 13 continues the heat generation until the heating device 13 is controlled to stop the heat generation by the control section 14.

In S23, the control section 14 determines whether communication of the desired data by the transceiver 12 is terminated or not. When the control section 14 determines that the communication of the data is terminated, the processing proceeds to S24.

Alternatively, it may be determined that the communication of the data is terminated when it is determined that a contact release sense signal is outputted from the touch sensor 16 or when it is determined that a communication error of the transceiver 12 occurs.

In S24, the control section 14 controls the transceiver 12 to disconnect its communication and controls the heating device 17 to stop the heat generation. In addition, if the heating device 17 is composed of a peltier element, the control section 14 may control the heating device 17 to stop the heat generation and further start heat absorption or cooling.

According to the above described processing, since a user can sense that communication is being performed from heat conducted from the electrode 11a when the user contacts the user's human body 2 with the electrode 11a, the user can intuitively know start, continuation and end of the communication between the first communication device 101-1 and the second communication device 101-2 through the human body 2.

Particularly, if heat generation is started at the start of communication and heat absorption is started at the end of communication, termination of the communication can be clearly recognized.

### Fourth Embodiment

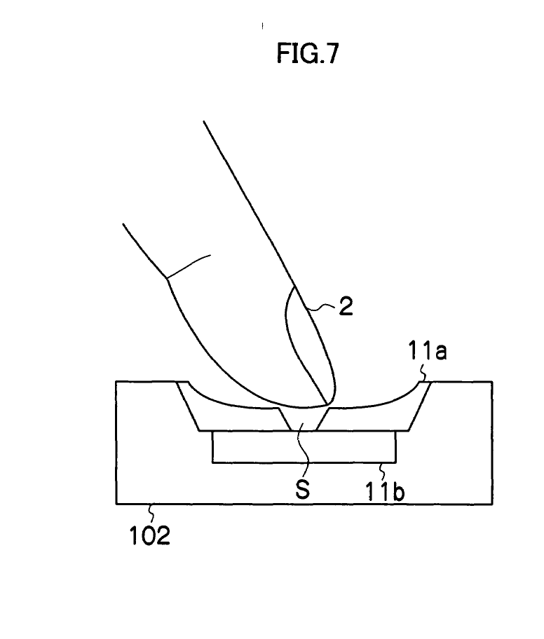

FIG. 7 is a block diagram of the main part of a human communication section 102 according to the fourth embodiment. The human body communication section 102 includes an electrode 11a which is an electronically conductive member that is fairly bent and formed in a concave shape, and a pressure reducing device 11b which reduces pressure by absorbing air from the concave space of the electrode 11a. Other components are similar to those of FIG. 2, and illustrations and descriptions thereof are omitted.

When the human body 2, e.g., a finger is pushed into the concave portion of the electrode 11a, the concave portion is closely contacted with the human body 2 so that a space S which is almost cut off from the outside world is formed. The pressure reducing device 11b absorbs air of the space S so that the space S is in an almost vacuum state and therefore the concave portion is more closely contacted with the human body 2.

When a touch sense signal is outputted from the touch sensor 16, the control section 14 controls the pressure reducing device 11b to absorb air of the space S, and also controls the transceiver 12 to start sending/receiving of desired data. The user can sense that communication is stared in response to the human body 2 being pulled.

In addition, when the control section 14 determines that the communication of the data is terminated, the control section 14 controls the pressure reducing device 11b to flow air into the space S so as to release the contact between the electrode 11a and the human body 2. The user can sense that the communication is terminated in response to detaching of the human body 2 from the electrode 11a.

### Fifth Embodiment

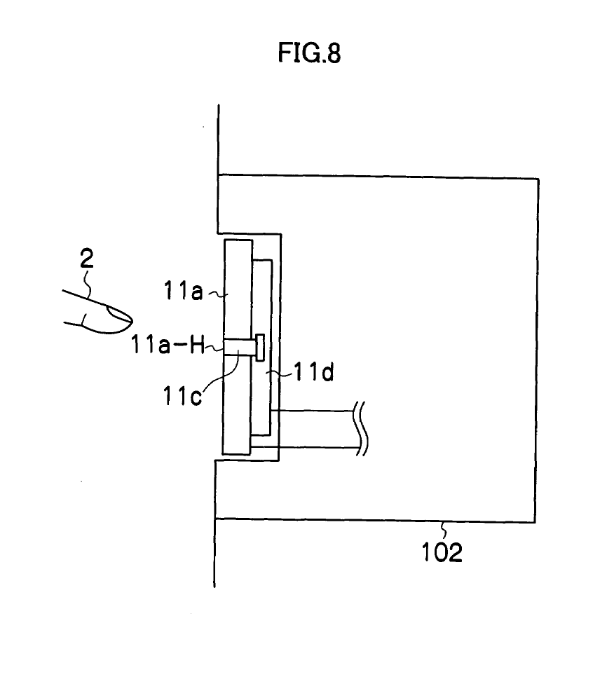

FIG. 8 is a block diagram of the main part of a human communication section 102 according to the fifth embodiment. The human communication section 102 includes a flat-plate electrode 11a through which a hole 11a-H is formed in a central or another portion thereof, a projecting part 11c which is a convex-shaped member arranged to be projectable to a human body 2 contacting side of the electrode 11a through the hole 11a-H, and an operation device 11d which performs operations of projection and retraction of the projecting part 11c. Other components are similar to those of FIG. 2, and illustrations and descriptions thereof are omitted.

The operation device is composed of a mechanical power generating device such as a motor or piezo element.

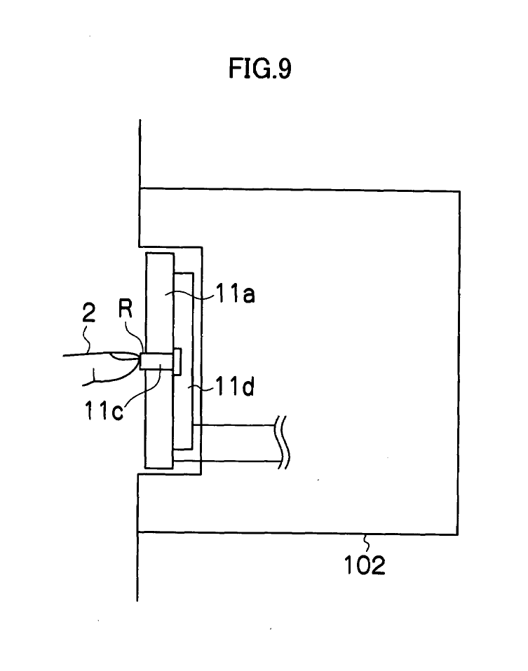

The projecting part 11c projects from the hole 11a-H so as to form a protrusion R on the human body 2 contacting side of the flat-plate electrode 11a, and therefore contacts the human body 2 (FIG. 9). When the projecting part 11c is retracted through the hole 11a-H, the protrusion R on the electrode 11a is disappeared, and the electrode 11b forms its original flat-plate shape (FIG. 8).

When a contact sense signal is outputted from the touch sensor 16, the control section 14 controls the operation device 11d to project the projecting part 11c from the hole 11a-H, and also controls the transceiver 12 to start sending/receiving of desired data. The user can sense that communication is started in response to the human body 2 in contact with the protrusion R.

Additionally, as in the first embodiment, the operation device 11d may generate vibration force to transmit it to the projecting part 11c after the projecting part 11c is projected. The user can easily sense that communication is being performed since vibration is transmitted from the protrusion R to the human body 2 in contact therewith.

In addition, when the control section 14 determines that the data communication is terminated, the control section 14 controls the operation device 11d to retract the projecting part 11c through the hole 11a-H. The user can sense that the communication is terminated in response to the human body 2 away from the protrusion R. After the projecting part 11c is retracted, vibration force generation of the operation part 11d is stopped.

### Sixth Embodiment

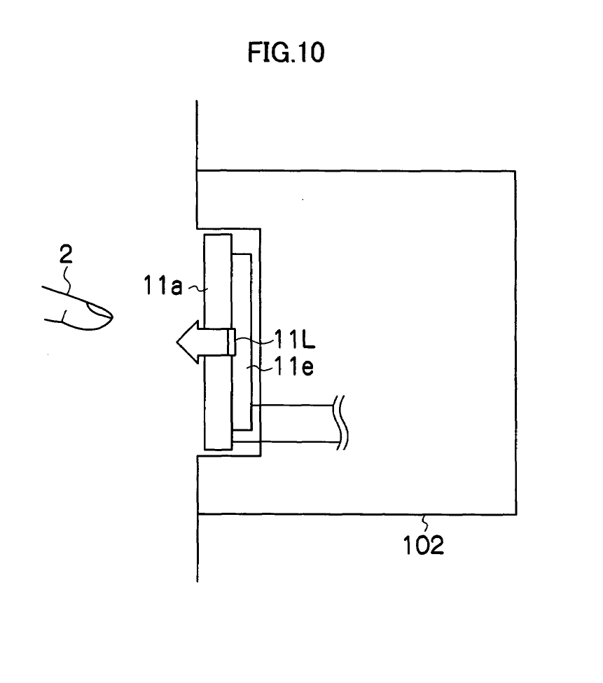

FIG. 10 is a block diagram of the main part of a human communication section 102 according to the sixth embodiment. The human body communication section 102 includes an electrode 11a, and a light emitting device 11e which cause a light emitting section 11L to emit light. The light emitting section 11L is composed of an LED, a fluorescent tube, an organic EL element, or the like. Other components are similar to those of FIG. 2, and illustrations and descriptions thereof are omitted.

The electrode 11a is composed of an electrically conductive member through which light is transmitted from the light emitting section 11L. The member may be a transparent electrode film or ITO film commonly used for a touch panel and the like, or a conductor embedded in a film in a mesh or lattice pattern. The electrode 11a and the touch sensor 16 may be integrated in a common member.

The light emitting section 11L and the light emitting device 11e are provided on the side which the human body 2 does not contact, and light is transmitted through the electrode 11a from the human body 2 non-contacting side to the human body 2 contacting side. However, if the light emitting section 11L is able to irradiate light to a neighborhood of a portion which the human body 2 contacts, the light emitting section 11L may be provided on the human body 2 contacting side.

When a touch sense signal is outputted from the touch sensor 16, the control section 14 controls the light emitting device 11e to cause the light emitting section 11L to emit light, and also controls the transceiver 12 to start sending/receiving of desired data. Since the user looks at the electrode 11a when contacting the human body 2 with the electrode 11a, the user can sense that communication is started from light emission from the light emitting section 11L without especially changing the user's view direction.

In addition, when the control section 14 determines that the communication of the data is terminated, the control section 14 controls the light emitting device 11e to stop light emission of the light emitting section 11L. The user can sense that the communication is terminated from the stop of light emission from the light emission 11L without changing the user's view direction.

### Seventh Embodiment

The human body communication section 102 may be composed of a combination of at least two of the above described components, that is, the electrode 11a, the pressure reducing device 11b, the projecting part 11c, the operation device 11d, the light emitting section 11L and light emitting device 11e, the vibration generator 13, and the heating device 17. In this case, a common structure of the combination of blocks may be integrated. For example, the operation section 11d and the vibration generator 13 may be composed of the same piezo element.

Alternatively, the light emitting section 11L and the heating device 17 may be composed of a halogen lamp, which has a wide radiation spectrum from visible light to mid- and far-infrared rays and is used as a heat source as well as lighting, and therefore the light emitting section 11L and the heating device 17 may be integrated so that the number of parts is reduced.

What is claimed is:

1. A communication device comprising:
a contact part which contacts a human body;
a communication section which performs data communication through the human body in contact with the contact part;
an energy generating section which generates energy including at least one of mechanical energy, heat energy, and light energy to apply the energy to the contact part;
a status detection section which detects a status of the data communication of the communication section; and
a communication status notification section which controls start, continuation, or stop of the energy generation of the energy generating section depending on the status of the data communication detected by the status detection section.

2. The communication device according to claim 1, wherein the energy generating section comprises a vibration generating section which generates vibration force.

3. The communication device according to claim 1, wherein the energy generating section comprises a heat radiating section which radiates heat to a human body contacting side of the contact part.

4. The communication device according to claim 1, wherein the energy generating section comprises a heat absorbing section which absorbs heat from a human body contacting side of the contact part.

5. The communication device according to claim 3, wherein the energy generating section comprises a heat absorbing section which absorbs heat from a human body contacting side of the contact part.

6. The communication device according to claim 1, wherein the energy generating section comprises an absorption section which sticks the human body in contact with the contact part to the contact part.

7. The communication device according to claim 1, further comprising a projecting part configured to be projectable to a human body contacting side of the contact part and be retractable to a human body non-contacting side of the contact part,
wherein the energy generating section comprises a drive section which drives operation of projection or retraction of the projecting part.

8. The communication device according to claim 1, wherein the energy generating section comprises a light emitting section which emits light to a human body contacting side of the contact part.

9. The communication device according to claim 1, wherein the communication status notification section controls start or stop of the energy generation of the energy generating section depending on detection of start or end of the data communication by the status detection section.

10. The communication device according to claim 2, wherein the communication status notification section controls start or stop of the energy generation of the energy generating section depending on detection of start or end of the data communication by the status detection section.

11. The communication device according to claim 3, wherein the communication status notification section controls start or stop of the energy generation of the energy generating section depending on detection of start or end of the data communication by the status detection section.

12. The communication device according to claim 4, wherein the communication status notification section controls start or stop of the energy generation of the energy generating section depending on detection of start or end of the data communication by the status detection section.

13. The communication device according to claim 5, wherein the communication status notification section controls start or stop of the energy generation of the energy generating section depending on detection of start or end of the data communication by the status detection section.

14. The communication device according to claim 6, wherein the communication status notification section controls start or stop of the energy generation of the energy generating section depending on detection of start or end of the data communication by the status detection section.

15. The communication device according to claim 7, wherein the communication status notification section controls start or stop of the energy generation of the energy generating section depending on detection of start or end of the data communication by the status detection section.

16. The communication device according to claim 8, wherein the communication status notification section controls start or stop of the energy generation of the energy generating section depending on detection of start or end of the data communication by the status detection section.

17. The communication device according to claim 9, wherein the communication status notification section controls the energy generation to be continued since the status detection section detects the start of the data communication until the status detection section detects the end of the data communication.

18. The communication device according to claim 10, wherein the communication status notification section controls the energy generation to be continued since the status detection section detects the start of the data communication until the status detection section detects the end of the data communication.

19. The communication device according to claim 11, wherein the communication status notification section controls the energy generation to be continued since the status detection section detects the start of the data communication until the status detection section detects the end of the data communication.

20. The communication device according to claim 12, wherein the communication status notification section controls the energy generation to be continued since the status detection section detects the start of the data communication until the status detection section detects the end of the data communication.

21. The communication device according to claim 13, wherein the communication status notification section controls the energy generation to be continued since the status detection section detects the start of the data communication until the status detection section detects the end of the data communication.

22. The communication device according to claim 14, wherein the communication status notification section controls the energy generation to be continued since the status detection section detects the start of the data communication until the status detection section detects the end of the data communication.

23. The communication device according to claim 15, wherein the communication status notification section controls the energy generation to be continued since the status detection section detects the start of the data communication until the status detection section detects the end of the data communication.

24. The communication device according to claim 16, wherein the communication status notification section controls the energy generation to be continued since the status detection section detects the start of the data communication until the status detection section detects the end of the data communication.

25. The communication device according to claim 1, wherein the communication status notification section changes a pattern of the energy generation of the energy generating section depending on the status of the data communication detected by the status detection section.

26. The communication device according to claim 17, wherein the communication status notification section changes a pattern of the energy generation of the energy generating section depending on the status of the data communication detected by the status detection section.

27. The communication device according to claim 18, wherein the communication status notification section changes a pattern of the energy generation of the energy generating section depending on the status of the data communication detected by the status detection section.

28. The communication device according to claim 19, wherein the communication status notification section changes a pattern of the energy generation of the energy generating section depending on the status of the data communication detected by the status detection section.

29. The communication device according to claim 20, wherein the communication status notification section changes a pattern of the energy generation of the energy generating section depending on the status of the data communication detected by the status detection section.

30. The communication device according to claim 21, wherein the communication status notification section changes a pattern of the energy generation of the energy generating section depending on the status of the data communication detected by the status detection section.

31. The communication device according to claim 22, wherein the communication status notification section changes a pattern of the energy generation of the energy generating section depending on the status of the data communication detected by the status detection section.

32. The communication device according to claim 23, wherein the communication status notification section changes a pattern of the energy generation of the energy generating section depending on the status of the data communication detected by the status detection section.

33. The communication device according to claim 24, wherein the communication status notification section changes a pattern of the energy generation of the energy generating section depending on the status of the data communication detected by the status detection section.

34. A communication device, comprising:
a contact part which contacts a human body;
a communication section which performs data communication through the human body in contact with the contact part;
a light emitting section which irradiates light to a neighborhood of a human body contacting side of the contact part;
a status detection section which detects a status of the data communication of the communication section; and
a communication status notification section which controls start, continuation, or stop of light emission of the light emitting section depending on the status of the data communication detected by the status detection section.

35. A communication status notification method used in a communication device including a contact part which contacts a human body and a communication section which performs data communication through the human body in contact with the contact part, the method comprising the steps of:
detecting a status of the data communication of the communication section; and
generating energy including at least one of mechanical energy, heat energy, and light energy to apply the energy to the contact part depending on the detected status of the data communication.

36. A communication status notification method used in a communication device including a contact part which contacts a human body and a communication section which performs data communication through the human body in contact with the contact part, the method comprising the steps of:
detecting a status of the data communication of the communication section; and
irradiating light to a neighborhood of a human body contacting side of the contact part depending on the detected status of the data communication.
